(19) United States
(12) Patent Application Publication
(10) Pub. No.: US 2011/0052026 A1
(43) Pub. Date: Mar. 3, 2011

(54) Method and Apparatus for Determining Angulation of C-Arm Image Acquisition System for Aortic Valve Implantation

(75) Inventors: Rui Liao, Princeton Junction, NJ (US); Yefeng Zheng, Dayton, NJ (US); Matthias John, Numberg (DE); Alois Noettling, Pottenstein (DE); Jan Boese, Eckental (DE)

(73) Assignees: Siemens Corporation, Iselin, NJ (US); Siemens Aktiengesellschaft, Munich (DE)

(21) Appl. No.: 12/858,494

(22) Filed: Aug. 18, 2010

Related U.S. Application Data
(60) Provisional application No. 61/237,733, filed on Aug. 28, 2009.

(51) Int. Cl. G06K 9/00

(52) U.S. Cl. 382/131; 382/128; 382/132

(57) ABSTRACT

A method and system for determining an angulation of a C-arm image acquisition system for aortic valve implantation is disclosed. One or more landmarks of the aortic root is detected in a 3D image. A plane representing an aortic annulus direction is defined in the 3D image based on the detected anatomic landmarks. A viewing angle is determined that is perpendicular to the defined plane.

This application claims the benefit of U.S. Provisional Application No. 61/237,733, filed Aug. 28, 2009, the disclosure of which is herein incorporated by reference.

### BACKGROUND OF THE INVENTION

The present invention relates to medical imaging of the heart, and more particularly, to using medical images of the heart to determine an angulation of a C-arm image acquisition system for aortic valve implantation.

Aortic valve disease is the most common valvular disease in developed countries, and has the second highest incidence among congenital valvular defects. Implantation of an artificial valve (i.e., valve prosthesis) is often necessary to replace a damaged natural valve. In minimally invasive valve implantations, a valve prosthesis is inserted via a catheter and X-ray imaging is used to support a physician in positioning and deployment of the valve prosthesis. In particular, during a valve implantation surgery, 2D fluoroscopic images (X-ray images) are often captured in real time using a C-arm image acquisition system to provide guidance to the physician.

For some types of valve prosthesis, such as Edwards Sapien, it is important that the X-ray images for guiding the valve implantation procedure are acquired at an angle that is perpendicular to the aortic annulus/aortic root. When the X-ray images are acquired at such an angle, a correct positioning of the valve prosthesis in the X-ray images yields a correct positioning in the aortic root. Furthermore, the chosen angulation for acquiring the X-ray images should allow angiograms (contrast enhanced X-ray images) to show the coronary ostia well. Otherwise, the physician may position the valve prosthesis such that the valve prosthesis accidently closes the coronary arteries. Some other types of valve prosthesis, such as Ventor Embracer, are not rotationally symmetric, which means that the valve prosthesis must be positioned so that its commissures are placed close to the patient's aortic root commissures. In this case, a physician must identify the aortic root commissures in the X-ray image. Accordingly, a challenge in conventional valve implantation is for the physician to find a good perpendicular view for the C-arm X-ray system.

In conventional valve implantation procedures, physicians typically select an angulation for a C-arm X-ray device by iteratively acquiring angiograms using a contrast agent. From each angiogram, a physician manually predicts a good angulation until an appropriate angulation for the valve implantation procedure is selected. This selection process typically requires at least 2-3 iterations. Accordingly, this selection process typically requires a large amount of contrast agent and is time consuming.

An automated method for that provides a precise angulation of the C-arm image acquisition system without exposing the patient to excessive contrast agent is desirable.

### BRIEF SUMMARY OF THE INVENTION

The present invention provides a method and system for determining an optimal angulation of a C-arm image acquisition system using 3D medical images. Embodiments of the present invention automatically determine a precise angulation for a C-arm image acquisition system. Embodiments of the present invention only require a single contrast injection, which limits a patient's exposure to contrast agent. Embodiments of the invention visualize the aortic root using 3D volume rendering and also provide additional relevant information, such as locations of the coronary ostia and the commissures.

In one embodiment of the present invention, one or more landmarks of the aortic root are detected in a 3D image. A plane representing an aortic annulus direction is defined in the 3D image based on the detected anatomic landmarks. An optimal viewing angle is then determined that is perpendicular to the defined plane.

These and other advantages of the invention will be apparent to those of ordinary skill in the art by reference to the following detailed description and the accompanying drawings.

### BRIEF DESCRIPTION OF THE DRAWINGS

FIG. 1 illustrates a method for determining an optimal angulation of a C-arm image acquisition system for aortic valve implantation according to an embodiment of the present invention;

FIG. 2 illustrates anatomic landmarks and a ring overlaid with an exemplary X-ray image;

FIG. 3 illustrates anatomic landmarks and a ring overlaid with another exemplary X-ray image;

FIG. 4 illustrates a method for automatically determining transfer function parameters for 3D volume rendering of a segmented aortic root according to an embodiment of the present invention; and

FIG. 5 is a high level block diagram of a computer capable of implementing the present invention.

### DETAILED DESCRIPTION

The present invention is directed to a method and system for determining an optimal angulation of a C-arm image acquisition system for aortic valve implantation using 3D medical images, such as DynaCT images, cardiac CT images, and cardiac MR images. Embodiments of the present invention are described herein to give a visual understanding of the method for determining an optimal angulation. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, it is to be understood that embodiments of the present invention may be performed within a computer system using data stored within the computer system.

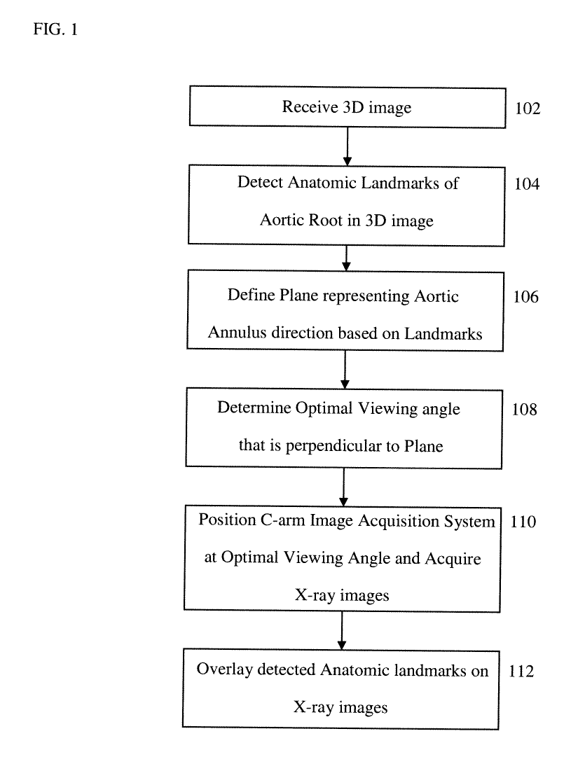

FIG. 1 illustrates a method for determining an optimal angulation of a C-arm image acquisition device for aortic valve implantation according to an embodiment of the present invention. The method of FIG. 1 transforms medical image data representing a cardiac region of a patient to detect and visualize various anatomic features of the patient and to determine the optimal angulation for C-arm X-ray acquisition for valve implantation.

At step 102, a 3D image of the aortic root of a patient is received. According to one embodiment, the 3D image can be a contrast enhanced C-arm CT volume (also referred to as a “DynaCT volume”), but the present invention is not limited thereto. It is also possible that the 3D image may be a computed tomography (CT) volume, magnetic resonance imaging (MRI) volume, etc. The 3D image can be received from an image acquisition device, such as a C-arm image acquisition system, or can be a previously stored volume loaded from memory or storage of a computer system, or some other computer readable medium.

At step 104, anatomic landmarks of the aortic roots are detected in the 3D image. According to an advantageous embodiment, three “hinge points” can be automatically detected in the 3D image. The three hinge points are the lowest points in the three aortic cusps in the 3D image. According to an advantageous embodiment, three aortic commissure points and the left and right coronary ostia can be automatically detected in the 3D image in addition to the three hinge points.

Although it is possible to detect each of the aortic anatomic landmarks separately, in an advantageous implementation, the hinge points, commissure points, and coronary ostia can be detected in the 3D image using a hierarchical approach which first detects global object (e.g., bounding box) representing all eight anatomical landmarks (3 hinge points, 3 commissures, and 2 coronary ostia) and then refines each individual anatomic landmark using specific trained landmark detectors. The position, orientation, and scale of the global object is detected by classifiers trained based on annotated training data using marginal space learning (MSL). In order to efficiently localize an object using MSL, parameter estimation is performed in a series of marginal spaces with increasing dimensionality. Accordingly, the idea of MSL is not to learn a classifier directly in the full similarity transformation space, but to incrementally learn classifiers in the series of marginal spaces. As the dimensionality increases, the valid space region becomes more restricted by previous marginal space classifiers. In particular, detection of the global object in the 3D image is split into three stages: position estimation, position-orientation estimation, and position-orientation-scale estimation. A separate classifier is trained based on annotated training data for each of these steps. This object localization results in an estimated transformation (position, orientation, and scale) of the object, and a mean shape of the object is aligned with the 3D volume using the estimated transformation. Boundary delineation of the estimated object shape can then be performed by non-rigid deformation estimation (e.g., using an active shape model (ASM)). The specific landmark detectors for the hinge points, commissure points, and coronary ostia can be trained position detectors that search for the specific landmarks in a region constrained by the detected global object.

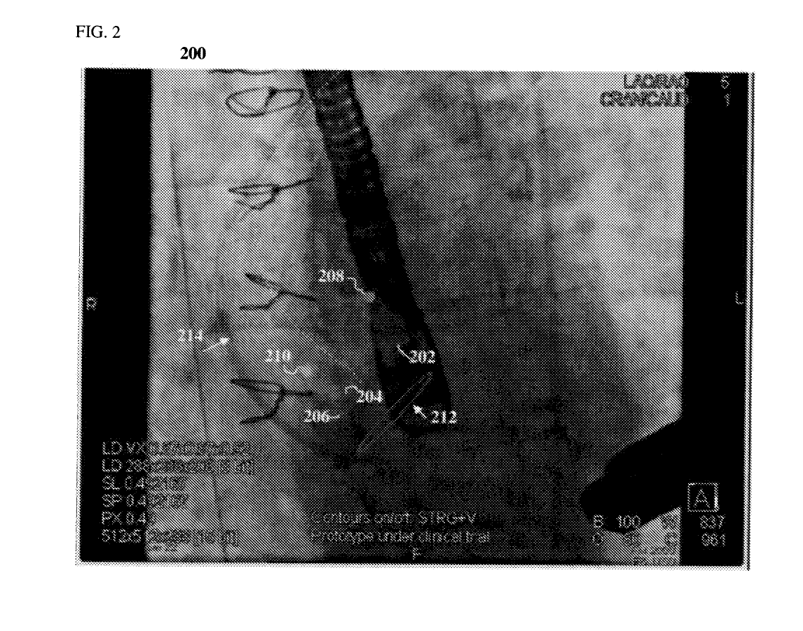

In addition to detecting the anatomic landmarks, such as the hinge points, commissure points, and coronary ostia, it is also possible that the aortic root be segmented in the 3D image. The aortic root can be segmented using MSL. As described above, and illustrated in FIG. 2, in MSL-based segmentation, after estimating the pose (position, orientation, and scale) of an object, the mean shape of the object is aligned with the estimated pose as an initial estimate of the object shape. Although the aortic root should always be present in cardiac C-arm CT volumes, the length of the aortic root may vary significantly. Due to this structure variation, it is difficult to calculate a reliable mean shape for the aortic root in annotated training data. Accordingly, in order to train the MSL classifiers for detecting the aortic root, the shortest aortic root that is consistent in length across all of the training volumes is indentified, and the aortic roots of the training volumes are truncated to match the shortest aortic root. After truncating the aortic roots of the training data, the aortic roots are consistent in anatomy and MSL can be applied to train classifiers to detect and segment the aortic root. In particular, the mean shape of the truncated aortic roots in the training data is aligned with the estimated posed determined using the MSL classifiers. After the initial estimate for the pose of the aortic root is detected a learning based boundary model and active shape model can be used to for final boundary delineation of the aortic root. The segmentation of the aortic root and the rest of the aorta is described in greater detail in U.S. patent application Ser. No. 12/725,679, filed Mar. 17, 2010, entitled “Method and System for Automatic Aorta Segmentation”, which is incorporated herein by reference.

As described above, in one embodiment, hinge points are anatomic landmarks detected at step 104. In another embodiment, a centerline of the aortic root can be detected. For example, the centerline of the aortic root can be detected by detecting 2D circles representing the intersection of the aortic root with horizontal slices or cross sections of the 3D image using a trained circle detector, and tracking the centerpoints of the detected 2D circles. The aortic root can also be segmented by interpolating and connecting the detected 2D circles.

At step 106, a plane representing an aortic annulus direction is defined in the 3D image based on the detected anatomic landmarks. According to an advantageous embodiment, a plane can be defined by the three hinge points detected in the 3D image. This plane can be visualized in an image as a ring. In particular, a ring connecting the three hinge points lies in the plane defined by the three hinge points. When visualizing the ring representing the plane defined by the three hinge points in a displayed image, it is possible to offset the ring by a certain offset (e.g., 10 mm) from the hinge points, such that the ring and the hinge points can both be viewed in the displayed image. In an embodiment in which the centerline of the aortic root is detected at step 104, the plane representing the aortic annulus direction is defined as a plane that is perpendicular to the centerline at the aortic annulus. This plane can be visualized in an image of the aortic root as a ring that is perpendicular to the centerline.

At step 108, an optimal viewing angle is determined that is perpendicular to the defined plane. When viewing an image of the aortic root at a viewing angle that is perpendicular to the defined plane, the ring used to visualize the plane in the image will appear to be a line. However, since the C-arm image acquisition system can rotate with respect to two axes, there are multiple viewing angles that are perpendicular to any given plane.

According to an advantageous embodiment, an optimal viewing angle is automatically determined from the viewing angles that are perpendicular to the defined plane by optimization based one or more optimization parameters. Optimization parameters are parameters that can be used to mathematically select an optimal viewing angle from the viewing angles perpendicular to the defined plane. For example, the relative positions of the detected anatomic landmarks, such as the hinges, commissure points, coronary ostia, and aortic root centerline may be used to select an optimal viewing angle. In a possible implementation, one or more of the following criteria may be optimized using various weights to select an optimal viewing angle: (a) the coronary ostia should be visible on the boundary of the projected aortic root; (b) the viewing angle should be close to an anterior posterior (AP) C-arm angulation; and (c) the three aortic cusps should be well separated. In another possible implementation, an optimal viewing angle is determined at which the projection of the commissure points appears between the left and right coronary ostia and the centerline of the aortic root is parallel to the viewing direction. An objective function can be defined based on one or more optimization parameters and the objective function can be optimized to determine the optimal viewing direction. It is to be understood that one skilled in the art can devise an objective function that weights various optimization parameters, and well known optimization techniques can be used to optimize the objective function.

As descried above, an optimal viewing angle can be determined automatically using optimization based on various optimization parameters. In an alternative embodiment, a user (e.g., a physician) can view various viewing angles that are perpendicular to the defined plane and manually select an optimal viewing angle. In this case, the detected anatomic landmarks and the ring representing the defined plane can be visualized and overlaid on X-ray images taken with the C-arm image acquisition system. It is also possible that the segmented aortic root can be visualized and overlaid on the X-ray images. The segmented aortic root can be visualized using 3D volume rendering, with automatically determined transfer functions, as described in greater detail below. At viewing angles which are perpendicular to the defined plane, the ring overlaid on the X-ray image appears as a line. The user can view X-ray images at various angles at which the ring appears as a line (i.e., angles that are perpendicular to the defined plane) in order to select an optimal angle based on the relative positions of the detected anatomic landmarks in the various X-rays. Since the anatomic landmarks and aortic root are overlaid with the X-ray images, it is possible to select an optimal angulation for the C-arm system without the use of additional contrast agent.

FIG. 2 illustrates anatomic landmarks and a ring overlaid with an exemplary X-ray image. As illustrated in FIG. 2, hinge points 202, 204, and 206 and coronary ostia 208 and 210 detected in a DynaCT image are overlaid on an X-ray image 200 acquired using a C-arm image acquisition system. Ring 212 is defined based on the hinge points 202, 204, and 206 and offset from the hinge points 202, 204, and 206 by a certain offset value. Ring 212 defines a plane that represents an aortic annulus direction. The aortic root 214 is segmented in a DynaCT image, visualized by 3D volume rendering, and overlaid on X-ray image 200. As shown in FIG. 2, ring 212 does not appear as a line in X-ray image 200. Accordingly, the viewing angle of X-ray image 200 is not perpendicular to the plane defined by ring 212, and therefore cannot be an optimal viewing angle.

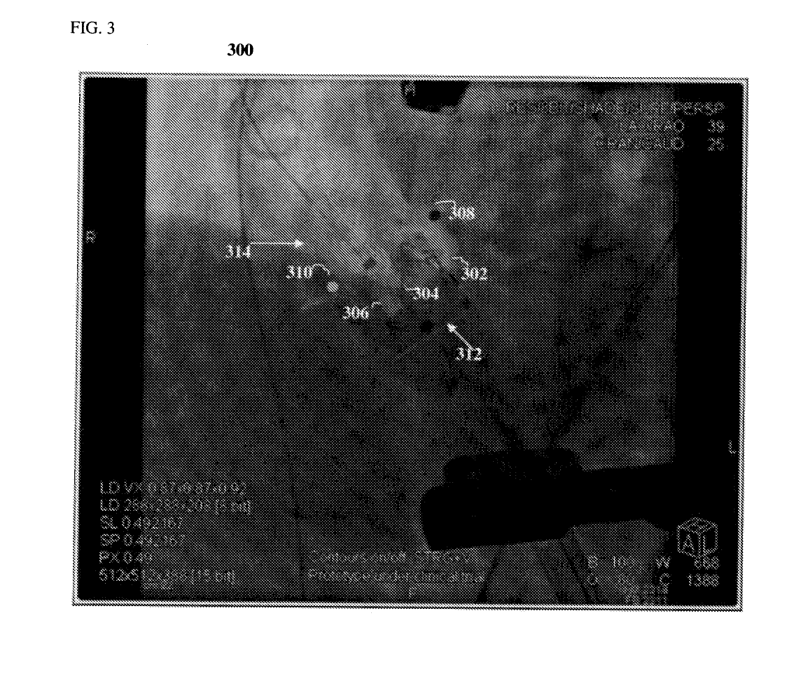

FIG. 3 illustrates anatomic landmarks and a ring overlaid with another exemplary X-ray image. As illustrated in FIG. 3, hinge points 302, 304, and 306 and coronary ostia 308 and 310 detected in a DynaCT image are overlaid on an X-ray image 300 acquired using a C-arm image acquisition system. Ring 312 is defined based on the hinge points 302, 304, and 306 and offset from the hinge points 302, 304, and 306 by a certain offset value. Ring 312 defines a plane that represents an aortic annulus direction. The aortic root 314 is segmented in a DynaCT image, visualized by 3D volume rendering, and overlaid on X-ray image 300. As shown in FIG. 3, ring 312 appears as a line in X-ray image 300. Accordingly, the viewing angle of X-ray image 300 is perpendicular to the plane defined by ring 312, and therefore is a possible optimal viewing angle.

Returning to FIG. 1, at step 110, the C-arm image acquisition system is positioned to the determined optimal viewing angle, and X-ray images are acquired for valve implantation using the C-arm image acquisition system. At step 112, the detected anatomic landmarks of the aortic root are overlaid on the X-ray images acquired at the optimal viewing angle. It is also possible that the 3D rendered segmented aortic root is overlaid on the X-ray images. This allows a physician to view the anatomic landmarks and/or the aortic root when performing the valve implantation, which can help the physician position the valve such that the detected anatomic commissure points are well overlaid with the prosthesis's commissures.

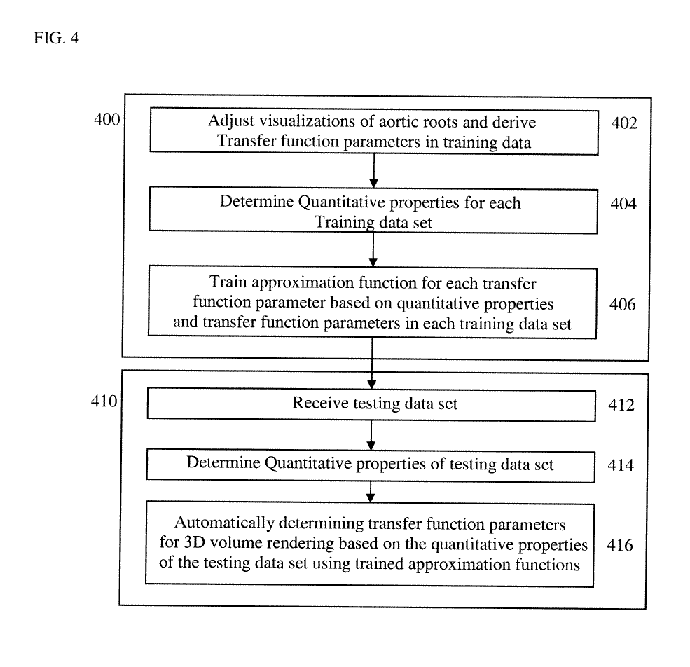

As described above, 3D volume rendering with automatically determined transfer function parameters can be used to visualize the aortic root. FIG. 4 illustrates a method for automatically determining transfer function parameters for 3D volume rendering of segmented aortic root according to an embodiment of the present invention. The method of FIG. 4 is divided into two stages, a training stage 400 and a testing stage 410.

The testing stage 400 includes steps 402-406. At step 402, a user manually adjusts volume visualizations of aortic roots in a set of training data and derives transfer function parameters for each training set. For example, the user can manually derive transfer function parameters such as width and center for each training data set. Each training data set is a volume in which an aortic root has been segmented. At step 404, for each training data set one or more quantitative properties are determined. For example, quantitative properties such as mean grey value of segmented volume voxels, mean grey vale of unsegmented volume voxels, standard deviation of segmented volume voxels, and standard deviation of unsegmented volume voxels may be determined for each training data set. According to an advantageous implementation, only those voxels in a training data set that are in the areas of interest (e.g., segmented aortic root) or close to the border of segmented and unsegmented voxels are used in determining the quantitative properties for the training data set. At step 406, for each transfer function parameter, an approximation function is trained based on the values of the quantitative properties and the transfer function parameters in each training data set. For a trained approximation function, the domain is the set of quantitative properties and the range is the corresponding transfer function parameter. Each trained approximation function can be trained by determining a function that bests interpolates or approximates the measured transfer function parameters and quantitative properties for all of the training data.

The training stage 410 includes steps 412-416. At step 412, a testing data set is received. The testing data set is a volume in which an aortic root has been segmented. At step 414, the quantitative properties of the testing data set are determined. The quantitative properties can be automatically determined from the aortic root segmentation. At step 416, the transfer function parameters for 3D volume rendering the segmented aortic root in the testing data set are automatically determined based on the quantitative properties of the testing data set using the trained approximation functions. Accordingly, the transfer function parameters, such as width and center, for 3D volume rendering a segmented aortic root are automatically determined without the need for user input.

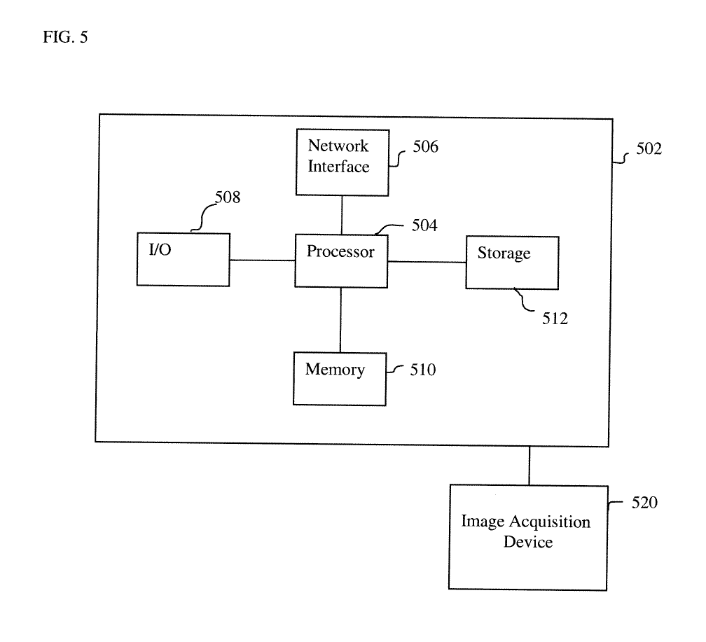

The above-described methods for determining an optimal angulation of a C-arm image acquisition system and for automatically determining transfer function parameters for 3D volume rendering a segmented aortic root may be implemented on one or more computers using well-known computer processors, memory units, storage devices, computer software, and other components. A high level block diagram of such a computer is illustrated in FIG. 5. Computer 502 contains a processor 504 which controls the overall operation of the computer 502 by executing computer program instructions which define such operation. The computer program instructions may be stored in a storage device 512, or other computer readable medium (e.g., magnetic disk, CD ROM, etc.) and loaded into memory 510 when execution of the computer program instructions is desired. Thus, the steps of the methods of FIGS. 1 and 4 may be defined by the computer program instructions stored in the memory 510 and/or storage 512 and controlled by the processor 504 executing the computer program instructions. An image acquisition device 520 can be connected to the computer 502 to input images to the computer 502. For example the image acquisition device 520 may be a C-arm image acquisition system capable of inputting 3D C-arm CT images and 2D fluoroscopic (X-ray) images to the computer 502. It is possible to implement the image acquisition device 520 and the computer 502 as one device. It is also possible that the image acquisition device 520 and the computer 502 communicate wirelessly through a network. The computer 502 also includes one or more network interfaces 506 for communicating with other devices via a network. The computer 502 also includes other input/output devices 508 that enable user interaction with the computer 502 (e.g., display, keyboard, mouse, speakers, buttons, etc.). One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for determining an angulation of a C-arm image acquisition system for aortic valve implantation, comprising:
detecting one or more anatomic landmarks of an aortic root in a 3D image;
defining a plane representing an aortic annulus direction in the 3D image based on the detected one or more anatomic landmarks; and
determining a viewing angle that is perpendicular to the defined plane.

2. The method of claim 1, wherein the 3D image is a 3D C-arm computed tomography (CT) image.

3. The method of claim 1, wherein said step of detecting one or more anatomic landmarks of an aortic root in a 3D image comprises:
detecting hinge points in the 3D image, wherein the hinge points are the lowest points of the aortic cusps in the 3D image.

4. The method of claim 3, wherein said step of defining a plane representing an aortic annulus direction in the 3D image based on the detected one or more anatomic landmarks comprises:
determining a plane defined by the hinge points.

5. The method of claim 1, wherein said step of detecting one or more anatomic landmarks of an aortic root in the 3D image comprises:
detecting a centerline of the aortic root in the 3D image.

6. The method of claim 5, wherein said step of defining a plane representing an aortic annulus direction in the 3D image based on the detected one or more anatomic landmarks comprises:
determining a plane that is perpendicular to the centerline of the aortic root at the aortic annulus.

7. The method of claim 1, wherein said step of determining a viewing angle that is perpendicular to the defined plane comprises:
automatically determining an optimal viewing angle that is perpendicular to the defined plane from a plurality of viewing angles that are perpendicular to the defined plane by optimizing one or more optimization parameters.

8. The method of claim 1, further comprising:
overlaying a ring representing the defined plane on one or more X-ray images acquired by the C-arm image acquisition system at one or more viewing angles.

9. The method of claim 8, wherein said step of determining a viewing angle that is perpendicular to the defined plane comprises:
selecting a viewing angle at which the ring representing the defined plane overlaid on an X-ray image appears as a line.

10. The method of claim 1, further comprising:
acquiring X-ray images using the C-arm image acquisition system at the determined viewing angle.

11. The method of claim 1, wherein said step of detecting one or more anatomic landmarks of an aortic root in a 3D image comprises:
detecting hinge points, commissure points, and left and right coronary ostia in the 3D image.

12. The method of claim 1, further comprising:
overlaying the detected anatomic landmarks on one or more X-ray images acquired by the C-arm image acquisition system.

13. The method of claim 1, further comprising:
segmenting the aortic root in the 3D image;
visualizing the segmented aortic root using 3D volume rendering; and
overlaying the visualized aortic root on one or more X-ray images acquired by the C-arm image acquisition system.

14. The method of claim 13, wherein said step of visualizing the segmented aortic root using 3D volume rendering comprises:
automatically determining transfer function parameters for 3D volume rendering of the segmented aortic root based on one or more quantitative properties of the 3D image using trained approximation functions.

15. An apparatus for determining an angulation of a C-arm image acquisition system for aortic valve implantation, comprising:
means for detecting one or more anatomic landmarks of an aortic root in a 3D image;
means for defining a plane representing an aortic annulus direction in the 3D image based on the detected one or more anatomic landmarks; and
means for determining a viewing angle that is perpendicular to the defined plane.

16. The apparatus of claim 15, wherein said means for detecting one or more anatomic landmarks of an aortic root in a 3D image comprises:
means for detecting hinge points in the 3D image, wherein the hinge points are the lowest points of the aortic cusps in the 3D image.

17. The apparatus of claim 16, wherein said apparatus defining a plane representing an aortic annulus direction in the 3D image based on the detected one or more anatomic landmarks comprises:
apparatus determining a plane defined by the hinge points.

18. The apparatus of claim 15, wherein said means for detecting one or more anatomic landmarks of an aortic root in the 3D image comprises:
means for detecting a centerline of the aortic root in the 3D image.

19. The apparatus of claim 18, wherein said means for defining a plane representing an aortic annulus direction in the 3D image based on the detected one or more anatomic landmarks comprises:
means for determining a plane that is perpendicular to the centerline of the aortic root at the aortic annulus.

20. The apparatus of claim 15, wherein said means for determining a viewing angle that is perpendicular to the defined plane comprises:
means for automatically determining an optimal viewing angle that is perpendicular to the defined plane from a plurality of viewing angles that are perpendicular to the defined plane by optimizing one or more optimization parameters.

21. The apparatus of claim 15, further comprising:
means for overlaying a ring representing the defined plane on one or more X-ray images acquired by the C-arm image acquisition system at one or more viewing angles.

22. The apparatus of claim 21, wherein said means for determining a viewing angle that is perpendicular to the defined plane comprises:
means for selecting a viewing angle at which the ring representing the defined plane overlaid on an X-ray image appears as a line.

23. The apparatus of claim 15, further comprising:
means for overlaying the detected anatomic landmarks on one or more X-ray images acquired by the C-arm image acquisition system.

24. The apparatus of claim 15, further comprising:
means for segmenting the aortic root in the 3D image;
means for visualizing the segmented aortic root using 3D volume rendering; and
means for overlaying the visualized aortic root on one or more X-ray images acquired by the C-arm image acquisition system.

25. The apparatus of claim 24, wherein said means for visualizing the segmented aortic root using 3D volume rendering comprises:
means for automatically determining transfer function parameters for 3D volume rendering of the segmented aortic root based on one or more quantitative properties of the 3D image using trained approximation functions.

26. A non-transitory computer readable medium encoded with computer executable instructions for determining an angulation of a C-arm image acquisition system for aortic valve implantation, the computer executable instructions defining steps comprising:
detecting one or more anatomic landmarks of an aortic root in a 3D image;
defining a plane representing an aortic annulus direction in the 3D image based on the detected one or more anatomic landmarks; and
determining a viewing angle that is perpendicular to the defined plane.

27. The computer readable medium of claim 26, wherein the computer executable instructions defining the step of detecting one or more anatomic landmarks of an aortic root in a 3D image comprise computer executable instructions defining the step of:
detecting hinge points in the 3D image, wherein the hinge points are the lowest points of the aortic cusps in the 3D image.

28. The computer readable medium of claim 27, wherein the computer executable instructions defining the step of defining a plane representing an aortic annulus direction in the 3D image based on the detected one or more anatomic landmarks comprise computer executable instructions defining the step of:
determining a plane defined by the hinge points.

29. The computer readable medium of claim 26, wherein the computer executable instructions defining the step of detecting one or more anatomic landmarks of an aortic root in the 3D image comprise computer executable instructions defining the step of:
detecting a centerline of the aortic root in the 3D image.

30. The computer readable medium of claim 29, wherein the computer executable instructions defining the step of defining a plane representing an aortic annulus direction in the 3D image based on the detected one or more anatomic landmarks comprise computer executable instructions defining the step of:
determining a plane that is perpendicular to the centerline of the aortic root at the aortic annulus.

31. The computer readable medium of claim 26, wherein the computer executable instructions defining the step of determining a viewing angle that is perpendicular to the defined plane comprise computer executable instructions defining the step of:
automatically determining an optimal viewing angle that is perpendicular to the defined plane from a plurality of viewing angles that are perpendicular to the defined plane by optimizing one or more optimization parameters.

32. The computer readable medium of claim 26, further comprising computer executable instructions defining the steps of:
overlaying a ring representing the defined plane on one or more X-ray images acquired by the C-arm image acquisition system at one or more viewing angles.

33. The computer readable medium of claim 32, wherein the computer executable instructions defining the step of determining a viewing angle that is perpendicular to the defined plane comprise computer executable instructions defining the step of:
selecting a viewing angle at which the ring representing the defined plane overlaid on an X-ray image appears as a line.

34. The computer readable medium of claim 26, further comprising computer executable instructions defining the step of:
overlaying the detected anatomic landmarks on one or more X-ray images acquired by the C-arm image acquisition system.

35. The computer readable medium of claim 26, further comprising computer executable instructions defining the steps of:
segmenting the aortic root in the 3D image;
visualizing the segmented aortic root using 3D volume rendering; and
overlaying the visualized aortic root on one or more X-ray images acquired by the C-arm image acquisition system.

36. The computer readable medium of claim 35, wherein the computer executable instructions defining the step of visualizing the segmented aortic root using 3D volume rendering comprise computer executable instructions defining the step of:
automatically determining transfer function parameters for 3D volume rendering of the segmented aortic root based on one or more quantitative properties of the 3D image using trained approximation functions.
